(19) United States
(12) Patent Application Publication
(10) Pub. No.: US 2018/0176087 A1
(43) Pub. Date: Jun. 21, 2018

(54) DATA PROCESSING UNIT AND METHOD FOR AUTO CONFIGURING DEVICES TO ACCESS THE INTERNET

(71) Applicant: Watchy Technology Private Limited, Bangalore (IN)

(72) Inventors: Sriramkumar HARIHARAN Vanamurthy, Chennai (IN); Vinoth Kumar VIVEKANANDA, Bangalore (IN)

(73) Assignee: Watchy Technology Private Limited, Bangalore (IN)

(21) Appl. No.: 15/869,051

(22) Filed: Jan. 12, 2018

(51) Int. Cl. H04L 12/24; G06F 9/4401

(52) U.S. Cl. CPC H04L 41/0886; G06F 9/4411; H04L 41/0806

(57) ABSTRACT

Method and data processing unit are provided for auto configuring devices to access the Internet. The method includes verifying whether a device, which has to be auto configured, has been auto configured previously by a data processing unit, which is now attempting to auto configure; and dialing using a dialing configuration that was successful previously with respect to the device, if the device was previously auto configured by the data processing unit.

### BACKGROUND

Unless otherwise indicated herein, the embodiments described in this disclosure are not prior art to the claims in this application and are not admitted to be prior art by inclusion in this section.

The subject matter in general relates to the field of networking. More particularly, but not exclusively, the subject matter relates to auto configuring an external data link device into a device through which the Internet may be accessed.

Conventionally Internet access is enabled via various means, such as, Ethernet, WiFi, ADSL and modem dial-up connection using Point to Point Protocol (referred to a “PPP modem”), among others.

PPP modems may be in the form of a device that can be engaged with a data processing unit to enable the data processing unit to access the Internet. Such engageable PPP modems are typically referred to as PPP dongles or Internet dongle. Typically, to use an Internet dongle, a user installs a driver in the data processing device. The driver may be specific to the Internet dongle. The user may have to further carry out various manual steps such as clicking on a button, making a selection or providing input, to convert the Internet dongle into a network device so that Internet may be eventually accessed by the data processing device. Aforementioned technique results in poor user experience.

The user experience is further adversely affected if multiple such Internet dongles have to be engaged and configured to operate with the data processing unit. Similarly, user experience is also adversely affected if different Internet dongles, which may not to be previously configured for use with the data processing unit, were to be used at different instances.

The poor user experience is not only related to the manual tasks that one may have to carry out to configure the Internet dongle as a network device, but also the time involved in configuring the Internet dongle as a network device.

In light of the foregoing discussion, there is a need for a technique for auto configuring an external modem device into a network device through which the Internet may be accessed.

### SUMMARY

An embodiment provides a data processing unit for auto configuring devices to access the Internet. The data processing unit configured to: select commands to request information required for selecting one or more dialing configurations, wherein the commands are selected based on a model of a device which the data processing unit is attempting to auto configure; request a response comprising the information required for selecting the one or more dialing configurations using the selected commands; receive one or more responses comprising the information required for selecting the one or more dialing configurations, in response to the request; select one or more dialing configurations at least by using the information required for selecting the one or more dialing configurations, wherein the information is part of the received one or more responses; and dial one or more of the selected one or more dialing configurations, wherein the device is auto configured into a device using which the Internet is accessible upon successful dialing.

Another embodiment provides a method for auto configuring devices to access the Internet. The method includes verifying whether a device, which has to be auto configured, has been auto configured previously by a data processing unit, which is now attempting to auto configure; an dialing using a dialing configuration that was successful previously with respect to the device, if the device was previously auto configured by the data processing unit.

Yet another embodiment provides a data processing unit for auto configuring devices to access the Internet. The data processing unit includes a plurality of commands for procuring information required for selecting one or more dialing configurations, wherein some of the commands are specific to some of the devices; a plurality of instructions for extracting information required for selecting one or more dialing configurations from responses received in response to the commands, from the devices, wherein some of the instructions are specific to some of the devices; and a plurality of dialing configurations, wherein one or more of the dialing configurations are selectable for dialing using the information required for selecting one or more dialing configurations.

### BRIEF DESCRIPTION OF DIAGRAMS

Embodiments are illustrated by way of example and not limitation in the Figures of the accompanying drawings, in which like references indicate similar elements and in which:

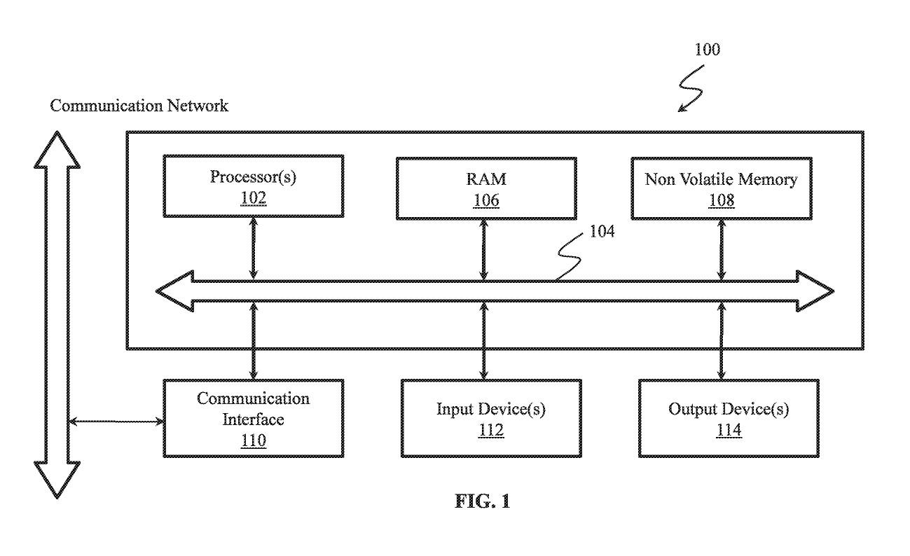

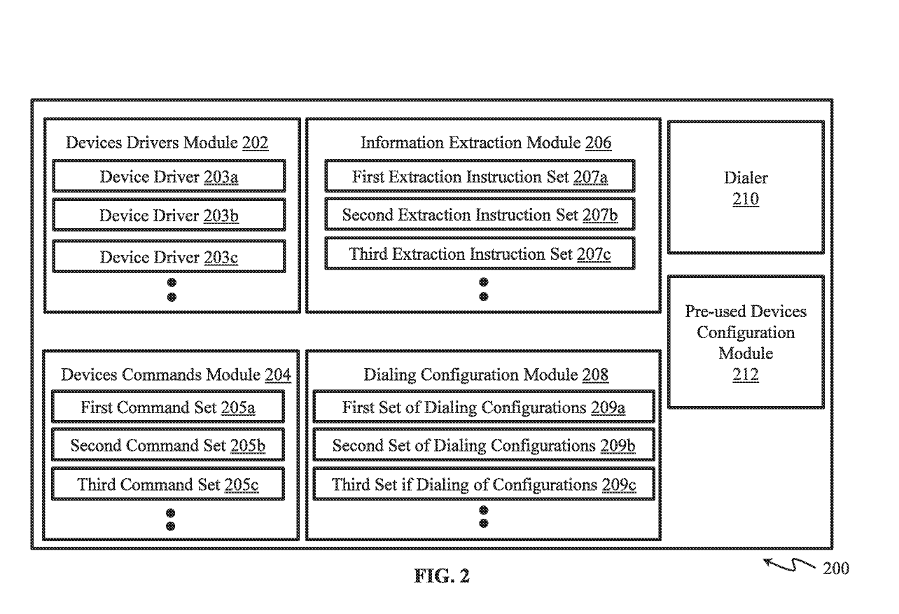

FIG. 1 is a block diagram of an example architecture of an example system 100 to auto configure device(s) into a devices through which the Internet is accessible;

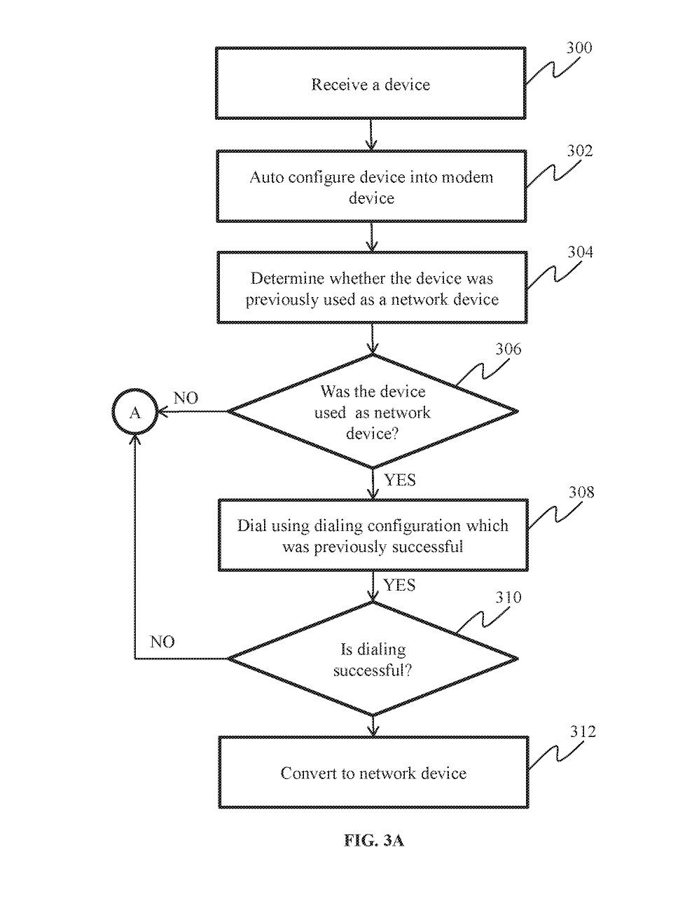

FIG. 2 is a block diagram illustrating modules of a Data Processing Unit (DPU) 200 for auto configuring devices engaged or engageable/adaptable with DPU 200 into devices through which the Internet is accessible; and

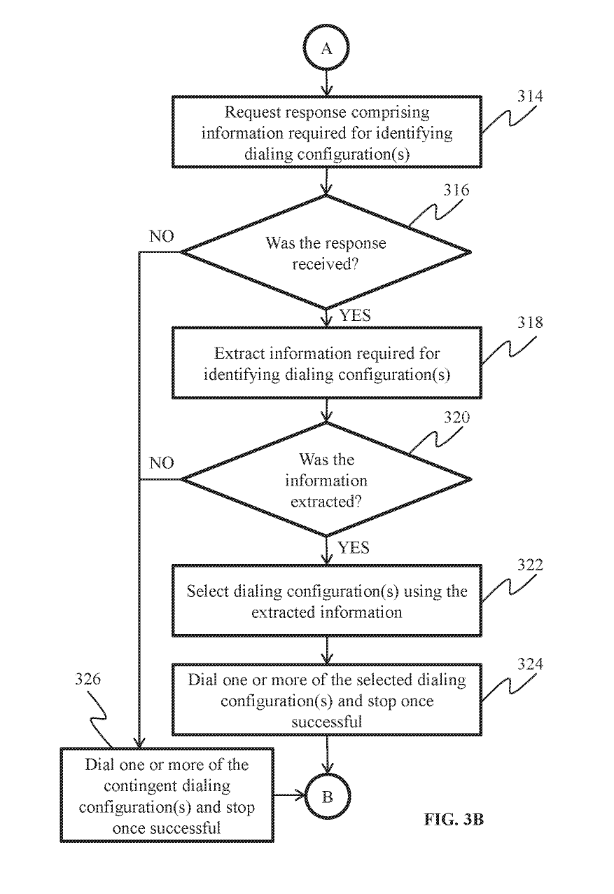

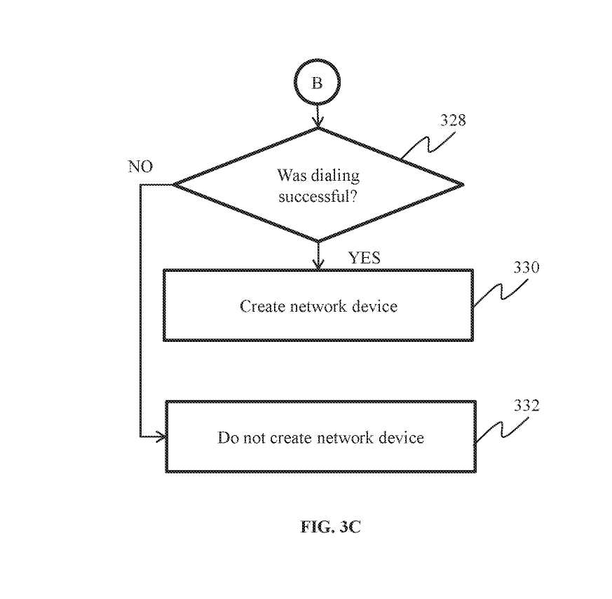

FIGS. 3A-3C are flowcharts of an example method for auto configuring devices into devices through which the Internet is accessible.

### DETAILED DESCRIPTION

### I. OVERVIEW

### II. SYSTEM ARCHITECTURE

### III. MODULES OF SYSTEM FOR AUTO CONFIGURATION

### IV. METHOD FOR AUTO CONFIGURATION

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a solution to auto configure multiple devices into network devices, through which internet may be accessed. The devices that are auto configured may be dial-up connection modems using Point to Point Protocol (referred to a “PPP modem”) or Wireless-N Modem. Such modems may be externally engaged to a Data Processing Unit (DPU), and may be referred to as Internet dongles. One or more Internet dongles may be engaged to a DPU and auto configured into network devices, thereby enabling the DPU or any device connected to the DPU to access the Internet via the configured network device(s).

The DPU includes pre-installed drivers corresponding to the Internet dongles supported by the DPU. Once an Internet dongle is engaged with the DPU, the DPU converts the Internet dongle into a data link device using the respective driver. Further, the Internet dongle's model details are used to ascertain the commands that have to be used to interact with the Internet dongle. Once the commands to be used are ascertained, the commands are used to identify the details about the network operator (may be referred to as operator) and the network type of the data card or SIM housed by the Internet dongle. The details about the network operator and the network type are used to identify the dialling configuration(s) that has to be tried. The identified dialling configuration(s) are used to dial, and upon successful dialling, the data link device is successfully converted into a device (network device) through which Internet may be accessed by the DPU. The dialling configuration may be stored in the DPU's memory against the unique identification code (e.g., IMEI and ESN) of the Internet dongle, so that a subsequent use of the Internet dongle with the DPU can skip unwanted steps and attempt dialling to convert the Internet dongle into a network device.

It is apparent from the foregoing overview that in this technique, the user just has to engage the Internet dongle to the DPU, and start using Internet (assuming successful execution by the DPU to convert the Internet dongle into a network device).

### II. System Architecture

Referring to the figures, more particularly to FIG. 1, an exemplary architecture of an exemplary system 100 to auto configure a device engaged with system 100 into a device through which the system 100 may access the Internet is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more computer processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### III. Modules of System for Auto Configuration

Referring to the figures, more particularly to FIG. 2, modules of a Data Processing Unit (DPU) 200 are provided for auto configuring a device or devices engaged or engageable/adaptable with DPU 200 into a device(s) (network device) through which the DPU 200 may access the Internet.

The devices that are auto-configured may be, as an example, dial-up connection modems using Point to Point Protocol (referred to a “PPP modem”) or Wireless-N Modem. The devices may be engaged, externally engaged or adapted with the DPU 200. The devices may be referred to as Internet dongles.

The devices may be auto configured into a data link device by the DPU 200 and subsequently auto configured into a device using which the DPU 200 may access the Internet. A device once auto configured to enable DPU 200 to access the Internet may be referred to as network device.

The DPU 200 may have the provision to receive one or more such devices simultaneously. The DPU 200 may even have provisions to receive or accommodate other modules/devices than the ones for which auto-configuration by the DPU 200 is attempted as per the disclosed subject matter. The other modules/devices may be for example Ethernet connection and WiFi module(s), among others.

The DPU 200 may include a devices drivers module 202, a devices commands module 204, a information extraction module 206, a dialing configuration module 208, a dialer 210 and a pre-used devices configuration module 212.

### Devices Drivers Module 202

The devices drivers module 202 includes a plurality of device drivers 203a, 203b, 203c and so on (may be referred to as “device driver 203” or “device drivers 203”). The device driver 203a may correspond to a first device model that the DPU 200 wishes to auto-configure into a network device. Likewise, the device driver 203b and the device driver 203c may correspond to the second and the third devices models, respectively, which the DPU 200 wishes to auto-configure.

The device drivers 203 may be preinstalled in the DPU 200. In other words, an end user may not bother installing these drivers in the DPU 200 to use the devices.

Once a device, whose corresponding device driver 203 is present in the DPU 200, is engaged with the DPU 200, the DPU 200 may use the corresponding device driver 200 to convert the device into a data link device. The DPU 200 identifies the unique identification code of the device (e.g., ESN/MEID/IMEI).

The DPU 200 also identifies the device model, which may be used by other modules in the DPU 200 to auto-configure the device into a network device.

Device model, as an example, can indicate the model code and software/firmware version, among others. In an embodiment, software/firmware version identity may be absent in the information that is considered as indicative of device model. The device model identity may be used by the devices commands module 204.

### Devices Commands Module 204

The devices commands module 204 may include commands that may be used to procure/request information from or about the device(s) that are converted into data link devices. As an example, the devices commands module 204 may include a first command set 205a, a second command set 205b, a third command set 205c and so on (may be referred to as command 205, commands 205, command set 205 or command sets 205). The command sets 205a, 205b, 205c may include commands to be used for first, second and third device models, respectively.

In an embodiment, the commands 205 are used to at least procure information (or part thereof) required for identifying dialing configuration(s).

In an embodiment, the information required for identifying dialing configuration includes information about the communication module, such as SIM card or data card, received or housed by the device. The information may include information identifying the operator (e.g., AIRTEL and VODAFONE) of the communication module. The information may further include type of network (e.g., GPRS, EDGE, 1XHSD, EVDO RevA, UMTS, EV-DO RevB, HSPA, HSPA+, 4G-TD-LTE, 4G-Wimax, 4G-TD-LTE and 4g-LTEA) that may be used by the communication module.

In an embodiment, several devices supported by the DPU 200 respond to a common command set 205. As an example, the first command set 205a may be used to procure/request information from or about more than one device. In such cases, information indicating the product models supported by a command set 205 may be stored in the DPU 200.

In an embodiment, a part of the information required to be procured may be done so by using a common command set 205, and the remaining part may be procured using another command set 205 that may be specific to that device model. As an example, a part of the information corresponding to the second device model required to be procured may be done so using the first command set 205a, and the remaining part may be procured using the second command set 205b, which may be specific to the second device model. As a simplistic example, the first part may be information identifying the operator and the remaining part may be information identifying the network type.

The data/information/answer obtained in response to the command may be further processed by the information extraction module 206.

### Information Extraction Module 206

The information extraction module 206 may include instructions that may be used to extract information required for identifying dialing configuration, from the answer(s) obtained in response to the commands 205. As an example, the information extraction module 206 may include a first extraction instruction set 207a, a second extraction instruction set 207b, a third extraction instruction set 206c and so on (may be referred to as instruction 207, instructions 207, instruction set 207 or instruction sets 207). The instruction sets 207a, 207b, 207c may include instructions to be used for extracting information for the answers obtained from the first, second and third device models, respectively.

It may be noted that the answer format provided by one device may be different from the answer format provided by another device. The information required for identifying dialing configuration will be in these answers. Hence, the piece of data/information within the answers may have to be extracted, so that the same can be used for dialing.

In an embodiment, the information extracted from the answer may be information identifying the operator (e.g., AIRTEL and VODAFONE) of the communication module in the device. Additionally, the information extracted from the answer may be information identifying the type of network (e.g., 2G and 3G) that may be used by the communication module.

In an embodiment, several devices supported by the DPU 200 may respond in the same answer format, and hence the same extraction instruction set 205 may be used for such devices. As an example, the first extraction instruction set 207a may be used to extract information from the answers provided by more than one device. In such cases, information indicating the product models supported by an extraction instruction set 207 may be stored in the DPU 200.

In an embodiment, a part of the information to be extracted may be done so by using a common extraction instruction set 207, and the remaining part may be extracted using another extraction instruction set 207 that may be specific to that device model. As an example, a part of the information to be extracted from answer provided by the second device model may be done so using the first extraction instruction set 207a, and the remaining part may extracted using the second extraction instruction set 207b, which may be specific to the second device model. As a simplistic example, the first part may be information identifying the operator and the remaining part may be information identifying the network type.

The information required for identifying dialing configuration(s) may be used by or with the dialing configuration module 208.

### Dialing Configuration Module 208

The dialing configuration module 208 may include several dialing configurations. As an example, the dialing configuration module 208 may include a first set of dialing configurations 209a, a second set of dialing configurations 209b, a third set of dialing configurations 209a and so on.

The first set of dialing configurations 209a may include one or more dialing configurations corresponding to a first operator (e.g., AIRTEL). As an example, the first set of dialing configurations 209a may include one or more dialing configurations corresponding to a combination of a first operator (e.g., AIRTEL) and a first network type (e.g., 3G).

The different dialing configuration in a set may be present to account for, as an example, the configurations corresponding to different geographies (e.g., circle). As an example, the dialing configuration for a first operator (or a combination of first operator and first network) for a first circle may be different compared to the dialing configuration for a first operator (or a combination of first operator and first network) for a second circle. Similarly, to account for different operators, circles and/or network types, plurality of dialing configurations may be included in the dialing configuration module 208.

In an embodiment, the dialing configuration module 208 may further include a plurality of contingent dialing configurations, which may be used for dialing, if the information, such as operator identity (plus network type in some example), required for selecting one or more dialing configurations is not procurable/retrievable/extractable. In an embodiment, one or more dialing configuration present in the contingent dialing configurations may be repeated in the sets of dialing configurations discussed earlier.

In an embodiment, based on the information used for identifying dialing configuration, one or more dialing configurations may be considered/selected for dialing. Alternatively, if said information is not procurable/retrievable/extractable then one or more of the contingent dialing configurations may be considered/selected for dialing.

### Dialer 210

The dialer 210 dials using the dialing configuration provided to it for dialing. Upon successful dialing, the device (which was configured into a data link device) is configured into a device (network device) through which the DPU 200 can access internet.

In an embodiment, the dialer 210 may stop dialing, even if there are pending dialing configurations selected/considered for dialing, once dialing is successful using one of the selected/considered dialing configuration.

### Pre-Used Devices Configuration Module 212

The pre-used devices configuration module 212 may store data/information corresponding to the devices which were previously used with the DPU 200.

In an embodiment, the module 212 stores unique identification code of the device (e.g., ESN/MEID/IMEI). In addition, if the device was previously successfully converted into a network device, then the dialing configuration, which was successful previously, may also be stored. It may be appreciated that, such storage will enable the DPU 200 to enable dialing using the successful dialing configuration, instead of carrying out steps to arrive at the dialing configuration. The module 212 may also store information (e.g., operator identity, plus in some example network type, plus geographic boundary/circle information in some examples) that may have been used previously to identify the dialing configuration(s). The module 212 may also store device model identity.

Further, in case the device was not successfully converted into a network device previously, then the information corresponding to failure may also be recorded. Even otherwise (not used previously), a failure to successfully convert a device into network device or any error even after converting the device into network device may result in storing data that may be used for error detection and product improvement. The data, based on the availability, may include one or more of unique identification code of the device, device model identity, operator identity, network type, dialing configuration(s) attempted/considered, circle information, stage at which error occurred and type of error, among others. Additionally, the DPU 200 unique identity may be recorded and one or more the data recorded may be provided or sent to a remote device for further study.

### IV. Method for Auto Configuration

Referring to the figures, more particularly to FIGS. 3A-3C, an exemplary method is provided for auto configuring devices engaged or engageable/adaptable with DPU 200 into devices (network device) through which the DPU 200 may access the Internet.

The device that has to be auto configured may be received by the DPU 200 (step 300). The received device may be auto configured by the DPU 200 into a data link device (step 302). The DPU 200 may determine whether the device was previously used as a network device (device using which Internet could have been accessed) (step 304). If the device was previously used as a network device (step 306), then the DPU 200 dials using a dialing configuration which was previously successful (step 308). The DPU 200 verifies whether dialing is successful (step 310). In case the dialing is successful, then the device is converted into a network device (step 312). Successful dialing can mean that the device has acquired IP address from a peer and is able to access the Internet.

In case the DPU 200 determines that the device was not previously used as a network device (step 306) or the DPU determines that dialing was not successful (step 310), then the DPU 200 requests the device for a response comprising information required for identifying dialing configuration(s) (step 314). The DPU 200 verifies whether a response or a requested response was received (step 316). In case the response was received, the DPU 200 attempts to extract information required for identifying dialing configuration(s) (step 318). The DPU 200 verifies whether information required for identifying dialing configuration(s) was successfully extracted (step 320). In case the information required for identifying dialing configuration(s) was successfully extracted, the DPU 200 selects dialing configuration(s) using the extracted information (322). One or more of the selected dialing configuration(s) are dialed to identify a successful dialing configuration, and any pending dialing configuration(s) may not be tried once dialing is successful (step 324). The DPU 200 verifies whether dialing was successful (step 328). If dialing was successful, then the device is converted into a network device through which internet may be accessed (330). In case dialing is not successful, then the device may not be auto configured into a network device (332).

In case the DPU 200 determines that a response or a requested response was not received (step 316) or in case the DPU 200 determines that information required for identifying dialing configuration(s) was not successfully extracted (step 320), then one or more of the contingent dialing configuration(s) may be dialed to identify a successful dialing configuration, and any pending contingent dialing configuration(s) may not be tried once dialing is successful (step 326). The process may then move to step 328.

The foregoing method will now be discussed in more detail. Referring to the step of receiving the device (step 300), the device may be engaged to or received by a port provided in the DPU 200. As discussed earlier, the DPU 200 may have provisions to receive a plurality of such devices, and may even have provisions to connect the DPU 200 to the Internet using technologies other than the devices that are attempted to be auto configured in the context of this description. The DPU 200 may attempt to auto configure each of such devices (e.g., internet dongles, PPP dongles, Wireless dongles or Ethernet over USB) into network device to enable the DPU 200 to access internet using one or all of the network devices.

The DPU 200 may auto configure the device engaged to or received by it into a data link device (step 302). The DPU 200 upon detecting that the device received by it is a device that is configurable into a data link device, may attempt to auto configure the device into a data link device. The DPU 200 may receive or extract the device model, based on which the DPU 200 may verify whether device driver 203 for the device model is present in the devices drivers module 200. In case a corresponding device driver 203 is present, then the DPU 200 may use the corresponding device driver 203 to convert the device into a data link device.

The DPU 200 may determine whether the device was previously used as a network device (device using which Internet could have been accessed) (step 304). In order to determine whether the device was previously used as a network device, the DPU 200 may use the unique identification code of the device (e.g., ESN/MEID/IMEI). The DPU 200 may retrieve the unique identification code from the device. The DPU 200 may verify the data/information/records in the pre-used devices configuration module 212 to check whether the device was used as a network device 200 in/with the DPU 200. As an example, if the device was used as a network device 200 in/with the DPU 200, then the unique identification code of the device along with other information (e.g., dialing configuration) may be stored in the pre-used devices configuration module 212.

In case, the DPU 200 determines that the device was used as a network device 200 in/with the DPU 200 (step 306), then the dialer 210 dials using dialing configuration which was previously successful to convert the device, which was configured as a data link device, into a network device (step 308). The dialing configuration which was previously successful may be retrieved from the pre-used devices configuration module 212. Said dialing configuration may be stored with the unique unique identification code of the device in the pre-used devices configuration module 212.

The DPU 200 verifies whether dialing was successful (step 310). Dialing may fail, as examples because, the operator of the data card/SIM card present inside the device may have changed, network type used by the data card/SIM card present inside the device may have changed, operator and network may not have changed but the dialing configuration may have changed for the same operator and network type, geographic boundary (e.g., circle) of the device may have changed, or geographic boundary (e.g., circle) of the device may not have changed but the dialing configuration for the same geographic boundary may have changed.

In an embodiment, the DPU 200 receives updates (e.g., from a remote location) to update dialing configurations 209 present in the dialing configuration module 208. Hence, failure in dialing is minimized especially when conditions (e.g., operator, network type and/or geographic boundary) for selecting dialing configuration has not changed from the previous instance of using the device as network device. In an embodiment, the pre-used devices configuration module 212 only stores identification or ID of the dialing configuration which was previously successful. The ID may be used to retrieve dialing configuration from the dialing configuration module 208. Such an arrangement simplifies the architecture of the DPU 200.

In case the DPU 200 verifies that dialing was successful (step 310), then the DPU 200 converts the device into a network device (step 312).

On the other hand, if the DPU 200 determines that dialing was not successful (step 310) or the device was not used as network device previously in/with the DPU 200 (step 306), then the DPU 200 may request response comprising information required for identifying dialing configuration(s), from the device (step 314). The response may be requested by sending commands/queries/instructions to the device. The DPU 200 may use a command set 205 present in the devices commands module 204 based on the device model. Further, as discussed earlier, a part of the information required to be procured may be done so by using a common command set 205, and the remaining part may be procured using another command set 205 that may be specific to that device model.

In an embodiment, the information required for identifying dialing configuration(s) includes operator information.

In another embodiment, the information required for identifying dialing configuration(s) includes operator information and network type. It may be noted that the dialing configuration(s) may be different for different network types. Hence, knowing the network type may enable the DPU 200 to select fewer number of dialing configurations for the dialer 210 to attempt dialing.

In yet another embodiment, the information required for identifying dialing configuration(s) includes operator information and geographic boundary (e.g., circle) in which the data card/SIM is located currently.

In yet another embodiment, the information required for identifying dialing configuration(s) includes operator information, network type and geographic boundary (e.g., circle) in which the data card/SIM is located currently.

In an embodiment, the geographic boundary (e.g., circle) in which the data card/SIM is located currently may not be provided by the device. It may be noted that the dialing configuration(s) may be different for different geographic boundaries (e.g., circles). Hence, knowing the geographic boundary in which the data card/SIM is located currently may enable the DPU 200 to select fewer number of dialing configurations for the dialer 210 to attempt dialing. The DPU 200 may be able to identify the geographic boundary in which the data card/SIM is located currently if the DPU 200 is already connected to the internet via means other than the device which is being configured. Said means as example, may include, Ethernet, WiFi or other such device(s) which have been configured as network device(s). The DPU 200, even though not connected to the internet while auto configuring the device, may still guess the geographic boundary based on the location or geographic boundary of the DPU 200 recorded previously within a predefined elapsed period. As an example, the DPU 200 may be have accessed internet via Ethernet 1 hour before, during which the DPU 200 records its location. Thereafter, while auto configuring the device, even if the DPU 200 is not connected to the Internet anymore, may still predict the geographic boundary based on the location recorded when DPU 200 was accessing Internet via Ethernet.

The DPU 200 verifies whether response comprising the information required for identifying dialing configuration(s) was received (step 316). In case the DPU 200 determines that the requested response was received, then the DPU 200 extracts information required for identifying dialing configuration(s) from the response (step 318). DPU 200 may use an extraction instruction set 207 based on the device model to extract the information required for identifying dialing configuration(s) from the response provided by the device. As discussed earlier, a part of the information to be extracted may be done so by using a common extraction instruction set 207, and the remaining part may be extracted using another extraction instruction set 207 that may be specific to that device model.

It may be noted that, in an embodiment, geographic boundary information, even if it were to be used for identifying dialing configuration(s), may not be present in theut. Alternatively geographic boundary information may be obtained as per the example technique discussed earlier.

The DPU 200 verifies whether the information for identifying dialing configuration(s) was extracted/obtained (step 320). In case the information for identifying dialing configuration(s) was obtained, then the DPU 200 selects one or more dialing configuration(s) 209 using said information (step 322) from the dialing configuration module 208. It may be noted that, in practice, typically one dialing configuration is identified. In most cases, said information will be sufficient to identify a single, and the right, dialing configuration.

The dialer 210 is provided the selected dialing configuration(s) for dialing. The dialer 210 may attempt dialing using the dialing configuration(s) till one of the dialing configurations is successful (step 324). The dialer 210 may be instructed to or the dialer may choose to ignore any selected but unattempted dialing configuration that may be pending once a dialing configuration is successful. Alternatively, the DPU 200 may stop providing pending dialing configuration(s), once a dialing configuration is successful. Once the DPU 200 determines that dialing is successful (step 328), then the device is converted into a network device (step 330), through which the DPU 200 or any device associated with it can access Internet. Further, upon success, data/information is stored in the pre-used devices configuration module 212, as discussed earlier.

In an embodiment, the selection of the dialing configurations may be expanded in case dialing is not successful. As an example, if dialing using the dialing configurations selected based on operator identity, network type and geographic boundary are not successful, the selection of dialing configurations may be expanded by ignoring geographic boundary. In case dialing even after the current level of expanded selection fails, then the selection may be further expanded by ignoring the network type. It may be noted that, with the expanded selection, the configurations that failed previously may also be part of the expanded selection, but may be ignored since they have been tried previously.

In case the DPU 200 determines that dialing using none of the selected dialing configuration(s) was successful, the device may not be converted into a network device. However, data/information may still be recorded in the pre-used devices configuration module 212. Alternatively, upon determination that dialing was not successful (step 328), upon determination that response comprising information required for identifying dialing configuration(s) was not received (step 316) or upon determination that information required for identifying dialing configuration(s) was not successfully extracted from the response (step 320), the DPU 200 may enable the dialer 210 to dial one or more of the contingent dialing configuration(s) and stop once successful (this step may be attempted once, and may not be a never ending loop) (step 326).

In an embodiment, even if it is determined that the device was previously used as a network device (step 306), it is verified whether one or more of the operator and network type of the device, compared to the operator and type registered when used previously, is the same. In one implementation, if at least one of the operator and network type has changed, then dialing configuration is determined as explained earlier.

In an embodiment, DPU 200 includes a module that includes dialing configuration for various device models. Said module may be updated by communicating updates from a remote location.

In an embodiment, the device model identity is used to verify whether dialing configuration for the device model identity is present in the module. In case the dialing configuration is present, then dialing is attempted.

In an embodiment, in case the above referred dialing is unsuccessful, then method described in connection with FIGS. 3A-3C is carried out, starting from step 304.

In an embodiment, the step of verifying whether dialing configuration for the device model identity is present in the module, and dialing if present, may be carried out before or after any suitable step in the method described in connection with FIGS. 3A-3C.

While particular embodiments of the present invention have been shown and described, it will be obvious to those skilled in the art that, based upon the teachings herein, changes and modifications may be made without departing from this invention and its broader aspects and, thus, the claims are to cover any such changes or modifications within the scope of this invention.

It shall be noted that the processes described above are described as sequence of steps; this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications; these should not be construed as limiting the scope of the invention but as merely providing illustrations of some of the personally preferred embodiments of this invention. Thus the scope of the invention should be determined by the appended claims and their legal equivalents rather than by the examples given.

What is claimed is:

1. A data processing unit for auto configuring devices to access the Internet, the data processing unit configured to:
select commands to request information required for selecting one or more dialing configurations, wherein the commands are selected based on a model of a device which the data processing unit is attempting to auto configure;
request a response comprising the information required for selecting the one or more dialing configurations using the selected commands;
receive one or more responses comprising the information required for selecting the one or more dialing configurations, in response to the request;
select one or more dialing configurations at least by using the information required for selecting the one or more dialing configurations, wherein the information is part of the received one or more responses; and
dial one or more of the selected one or more dialing configurations, wherein the device is auto configured into a device using which the Internet is accessible upon successful dialing.

2. The data processing unit of claim 1, comprising a plurality of commands to request information required for selecting one or more dialing configurations from a plurality of devices, wherein at least some of the commands are specific to specific devices.

3. The data processing unit of claim 2, wherein the commands are selected to request information required for selecting the one or more dialing configurations for the device, from the plurality of commands.

4. The data processing unit of claim 1, comprising a plurality of instructions for extracting information required for selecting one or more dialing configurations from responses received by a plurality of devices, wherein at least some of the instructions are specific to specific devices.

5. The data processing unit of claim 4, further configured to extract the information required for selecting the one or more dialing configurations for the device from the one or more responses received, using instructions selected from the plurality of instructions for extracting information required for selecting one or more dialing configurations from responses received by the plurality of devices, wherein the instructions are selected based on the model of the device.

6. The data processing unit of claim 1, wherein the information required for selecting the one or more dialing configurations for the device comprises network operator of a communication module of the device

7. The data processing unit of claim 6, wherein the information required for selecting the one or more dialing configurations for the device further comprises network type used by the communication module.

8. The data processing unit of claim 6, wherein the information required for selecting the one or more dialing configurations for the device further comprises information about a geographic boundary within which the device is located.

9. The data processing unit of claim 8, further configured to determine the geographic boundary based on information obtained from means using which the data processing unit had accessed or is accessing the Internet.

10. The data processing unit of claim 1, further configured to:
store unique identification code of the devices which it had previously auto configured to access the Internet; and
store information at least identifying dialing configuration that was successful in respect of each of such devices which it had previously auto configured.

11. The data processing unit of claim 10, further configured to:
verify whether the device, which the data processing unit is attempting to auto configure, has been auto configured by the data processing unit previously, using the unique identification code of the device; and
dial using the dialing configuration that was successful previously with respect to the device, wherein if the dialing is successful, the steps of claim 1 are considered redundant.

12. The data processing unit of claim 1, further configured to dial one or more of contingent dialing configurations if the information required for selecting the one or more dialing configurations is not retrievable.

13. The data processing unit of claim 1, further configured to dial one or more of contingent dialing configurations if dialing using the selected one or more dialing configurations is not successful.

14. The data processing unit of claim 1, further comprising a plurality of device drivers corresponding to the devices the data processing unit is designed to auto configure, wherein the device the data processing unit is attempting to auto configure is configured into a data link device using its respective device driver.

15. A method for auto configuring devices to access the Internet, the method comprising:
verifying whether a device, which has to be auto configured, has been auto configured previously by a data processing unit, which is now attempting to auto configure; and
dialing using a dialing configuration that was successful previously with respect to the device, if the device was previously auto configured by the data processing unit.

16. A method of claim 15, further comprising, if the device was not auto configured previously by the data processing unit or dialing is unsuccessful:
selecting commands to request information required for selecting one or more dialing configurations;
requesting a response comprising the information required for selecting the one or more dialing configurations using the selected commands;
receiving one or more responses comprising the information required for selecting the one or more dialing configurations, in response to the request;
selecting one or more dialing configurations at least by using the information required for selecting the one or more dialing configurations, wherein the information is part of the received one or more responses; and
dialing one or more of the selected one or more dialing configurations, wherein the device is auto configured into a device using which the Internet is accessible upon successful dialing.

17. The method of claim 16, wherein commands are selected based on a model of the device.

18. The method of claim 16, further comprising, verifying whether at least one of operator and network type of the device, which was auto configured previously, has changed from what was recorded previously, and carrying out the steps of claim 16 if at least one of the operator and the network type has changed.

19. A data processing unit for auto configuring devices to access the Internet, the data processing unit comprising:
a plurality of commands for procuring information required for selecting one or more dialing configurations, wherein some of the commands are specific to some of the devices;
a plurality of instructions for extracting information required for selecting one or more dialing configurations from responses received in response to the commands, from the devices, wherein some of the instructions are specific to some of the devices; and
a plurality of dialing configurations, wherein one or more of the dialing configurations are selectable for dialing using the information required for selecting one or more dialing configurations.

20. The data processing unit of claim 19, further comprising a plurality of device drivers, wherein at least some of the device drivers are specific to some of the devices, wherein a device that has to be auto configured is configured into a data link device using respective device driver.

21. The data processing unit of claim 19, further configured to:
select commands from the plurality of commands, based on a model of the device; and
plurality of instructions from the plurality of instructions, based on the model of the device.
